(19) United States
(12) Patent Application Publication
(10) Pub. No.: US 2004/0234766 A1
(43) Pub. Date: Nov. 25, 2004

(54) Method for packaging electronic devices

(76) Inventors: Yi-Hsuan Liu, Hsinchu County (TW); Ju-Liang He, Taichung County (TW)

Correspondence Address: BIRCH STEWART KOLASCH & BIRCH, PO BOX 747, FALLS CHURCH, VA, 22040-0747, US

(21) Appl. No.: 10/838,317

(22) Filed: May 5, 2004

(30) Foreign Application Priority Data
May 19, 2003 (TW) 092113414

(51) Int. Cl. C04B 2/10

(52) U.S. Cl. 428/403; 523/333; 106/770

(57) ABSTRACT

An improved method for packaging electronic devices by coating organic light emitting device uniformly with an encapsulation material which includes of nanometer inorganic powder and polymer, to form a moisture permeation resistant layer between the nanometer inorganic powder and the polymer after the solidification of the package layer.

### FIELD OF THE INVENTION

This invention relates to a method for packaging electronic devices, and more particularly to an improved method for packaging electronic devices that an encapsulation material could be directly coated on the surface of electronic devices for waterproofing and isolation, thus fulfilling the characteristics of flexible design for modern electronic product.

### BACKGROUND OF THE INVENTION

Safety is always a major issue of modern age. People are inclined to rely on the electronic products for convenience and ease of the living. There are conditions such that we use the video communication device in the bathroom, or use the portable electronic product on a rainy day.

Products of nowadays are highly equipped with electronic components, which suffer sudden electric breaks due to moisture. Consequent damage for this type of electronic component, malfunction of the product or even causing fire disaster could occur. Safety issue caused by moisture permeation in this regard is vitally important.

In addition to the safety issues mentioned above, moisture permeation is the primary concern to life expectancy of some opto-electronic devices. One of the known example is the organic light emitting diode (OLED), which emitting light from a very thin organic film with fast response, wide viewing angle, high resolution and high brightness. It is considered as next generation of flat panel display technology following thin film transistor liquid crystal display (TFT-LCD). Before that, moisture permeation should be strictly prohibited by a variety of processes, because of the moisture susceptible nature of the organic light emitting materials.

Damage to the OLED material caused by moisture permeation forms dark spots that begins at the moment when moisture leaks from an OLED device edge to oxidize cathode layer which normally in form of metal. In light emitting layer, metal oxide gives rise to poor contact with cathode layer, at the same time reducing the effective emitting area of the entire OLED device, eventually increasing the driving voltage of the OLED device and resulting in OLED device failure. It is then essential to isolate the OLED material from moisture attack.

Description of the package method that is traditionally used in the industrial production process of an organic light emitting device is listed below:

1. A method for packaging an organic light emitting diode device relates to the use of the organic light emitting diode devices on a substrate comprising:

a device formed on the substrate therein;

a cap packaged with the device region; wherein the cap having a space possible to contain the device; and

micro-particles supporting the cap forming the device region therein.

2. A method for forming a waterproof layer of organic light emitting devices relates to a manufacturing process of an organic electroluminescence component. There are multiple light emitting area in an organic electroluminescence display panel that is composed of a supporting substrate, a first electrode formed the response area of light emitting on the substrate, a grated photoresist layer located at top of the first electrode extruded from the substrate, an organic light emitting material that is deposited between the grated photoresist layer and the first electrode to form multiple area of the organic light emitting material on the first electrode, a second electrode formed on the organic light emitting material, a stress relaxation buffer layer formed on the second electrode to act as a silicon oxinitride film or a polymer film, a waterproof layer formed on the stress relaxation buffer layer to act as an amorphous silicon or an inorganic nitride or oxide.

3. A method for packaging organic light emitting devices relates to a method for packaging an emitting layer of the organic electroluminescence devices that the method is mainly to provide an encapsulation layer formed by the vacuum coating film of the organic electroluminescence within a low temperature environment.

4. A method for packaging an organic light emitting display device relates to a method for packaging an organic electroluminescence display device including:

providing an encapsulation substrate and an unpackaged organic electroluminescence device;

coating an encapsulation material on the surface of an encapsulation substrate;

forming an emitting layer on the organic electroluminescence device, wherein a surface of the organic electroluminescence device with the emitting layer directly corresponds to the surface of the encapsulation material to make a package improvement for the organic electroluminescence component after a solidification of the encapsulation material under a pressure and thermal process.

5. A method and a structure for protecting an organic electroluminescence display device relates to a manufacturing process of an organic electroluminescence display device, including:

a first electrode layer formed on the substrate;

an organic layer formed on the first electrode layer;

a second electrode layer formed on the organic layer to form a pixel matrix array by interlacing the first electrode layer and the second electrode layer, wherein the substrate, the first electrode layer, the organic layer and the second electrode layer constitute an organic electroluminescence component; and

a part of the second electrode layer covered by a protection layer, wherein the protection layer has an element of minimum electromotive force, this minimum electromotive force is smaller than the largest electromotive force in the second electrode layer to protect the organic light emitting component from permeation by moisture and oxygen; and an air-sealed cover prevents the organic light emitting component from being insulated by the exterior air and moisture.

6. A method for packaging an electroluminescence device, including at least the following steps:

Step 1. Providing a cover glass and a glass substrate in a moist and oxygen controlled environment. The glass substrate has several electroluminescence components and corresponds to the glass.

Step 2. In the moisture and oxygen controlled environments, a sealant is applied to several frame positions of the cover glass; the frame position is corresponded to the electroluminescence components. There are imperfections in every sealant.

In the moisture and oxygen controlled environment, the sealant and light emitting devices are placed between the cover glass and the glass substrate before press-fit.

Step 3. The sealant solidifies in the moisture and oxygen controlled environment.

Step 4. In the moisture and oxygen controlled environment, the cover glass and the glass substrate are cut according to the layout of the electroluminescence components.

Further, the light emitting devices are separated according to the cuts and form several independent package units in the moisture and oxygen controlled environment. This package unit is composed of a glass substrate element, an electroluminescence component, a part of sealant and a cover glass element, wherein a space is formed between the cover glass element, the glass substrate element and the part of sealant thereof.

Step 5. Providing a vacuum space with a gel tank containing encapsulation material at the bottom. Package units are placed into the vacuum space and the opening of package unit is directed to gel tank. The package unit is not in contact with the encapsulation material.

The space is pumped down so that the package units and encapsulation material are in the vacuum state.

Step 6. When it reaches an ultimate vacuum degree, the opening of package units are submitted to the gel tank waiting for the encapsulation material injection.

Increase the pressure to a preset level to inject the encapsulation material through opening and completely fill up the space of each package units separately and followed by solidifying the encapsulation material.

7. “The package method of organic EL devices” is a kind of package methods of organic Electroluminescent device including:

a method of forming organic EL devices, wherein providing a transparent substrate and several organic EL devices are formed on the transparent substrate thereof;

a method of forming plastic laminates and adhesion layer, wherein providing a plastic laminate and several adhesion layers are formed on the plastic laminate;

a method of forming package tin with a cavity space, wherein several cavity spaces are formed on the plastic laminate, and the plastic laminate with cavity spaces are treated as package tin; and a method of integrating packages, wherein the side with adhesion layer of the plastic laminate are joined to the organic EL devices with a transparent substrate. Thermal-cure or UV-Cure the adhesion layer to form integrated packages and therefore insulating the organic EL devices of the integrated packages form the exterior.

As a conclusion, traditional packaging methods are based on the non-flexible ITO glass panel over which the organic light emitting film and pre-defined cathode layer are sealed by encapsulation tin surrounded by the cured encapsulation, wherein water absorbent material is normally stored. The organic electroluminescence devices inside this package are therefore insulated from exterior moisture and oxygen.

Even though the opto-electronic devices can be insulated from moisture permeation with the above-mentioned package method, such traditional methods always failed to satisfy the need of flexible design of products which are recently developed. The problem of applying sealant around the package cover or fracture of the package caused by the bending of the device may happen.

### SUMMARY OF THE INVENTION

Instead of using the aforesaid traditional method of package cover, absorbent material and sealant, this invention discloses a method of applying a package layer formed by polymer with a mixture of nanometer inorganic powder on the electronic devices, and therefore avoiding the situation where stress concentration shortens the life duration.

The package layer according to this invention includes a mixture of nanometer inorganic powder and polymers, applied evenly on the electronic devices, a dense-structured layer is formed due to the strong chemical bond formation between high reactivity surface of the nano powder and polymer matrix, thus reinforcing the insulation of the electronic devices from moisture permeation.

### BRIEF DESCRIPTION OF THE DRAWINGS

FIG. 1 is a flow chart showing the method of the package of this invention

FIG. 2A˜2B is a schematic diagram showing the structure of the package of the organic light emitting diode of this invention

FIG. 3 is an another schematic diagram showing the structure of the package of the liquid crystal display of this invention

FIG. 4 is an another schematic diagram showing the structure of the package of the film battery of this invention

### DETAILED DESCRIPTION OF THE PREFERRED EMBODIMENTS

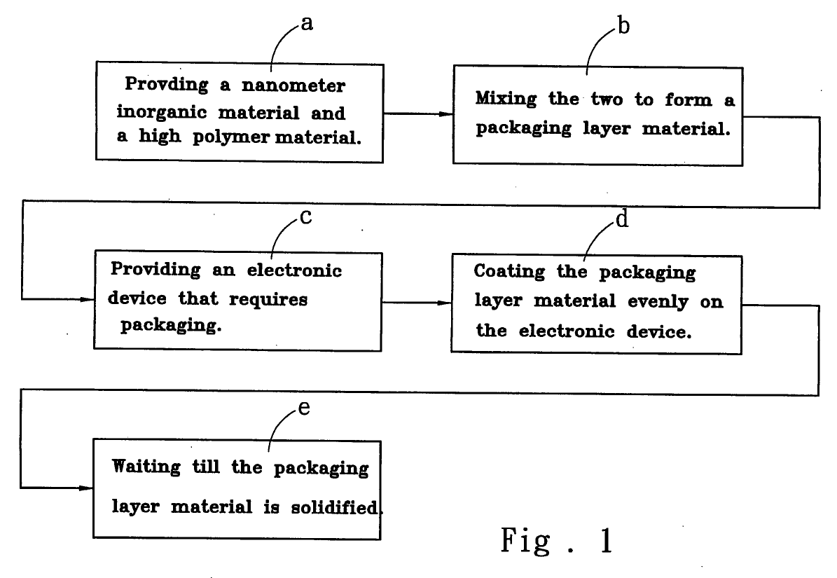

Referring to FIG. 1 depicts a packaging schematic flow diagram of an electronic device. The present invention provides a method for packaging an organic light emitting device of nanometer inorganic powder incorporated polymer in the following steps.

In the Step a, a nanometer inorganic powder and a polymer are provided, and a nanometer inorganic powder incorporated polymer manufactured by mixing different ratio of the nanometer inorganic powder and the polymer.

The nanometer inorganic powder is selected from one material of the group consisting of ferrum (Fe), aluminum (Al), titanium (Ti), platinum (Pt), magnesium (Mg), silver (Ag), chrome (Cr), silicon dioxide (SiO₂), titanium dioxide (TiO₂) and zinc dioxide (ZnO₂). The particle size of the nanometer inorganic powder is between 1 nm and 100 nm, and the nanometer inorganic powder is either prepared by using a sol-gel process or mechanical grinding method.

Furthermore, the polymer is selected from one material of group consisting of epoxy, acrylic, urethane, polyurethane, copolymer of epoxy/acrylic, polymer mixture forming of acrylic/urethane, silicone, silioxane and organic/inorganic polymer.

Simultaneously, strong chemical bonds or Van der Wall bonds, at least are formed between the nanometer inorganic powder surface and the polymer matrix to generate a dense structure of the nanopowder incorporated polymer.

In the Step b, an encapsulation slurry is formed by mixing the nanometer inorganic powder and the polymer, which is temporarily unsolidified and its viscosity is controlled in between 5,000 cps and 50,000 cps.

In the Step c, an electronic device to be packaged is provided.

In the Step d, the electronic device to be packaged is coated with the encapsulation slurry.

In the Step e, the packages of electronic devices are finished after solidification of the encapsulation slurry. Then, moisture permeation resistance can be tested to determine the optimized ratio of nanometer inorganic powder to polymer.

Here is an example using PET as bare material to form a “nano-titanium powder incorporated polymer” on it as waterproof film, which is further water permeation tested and described as follows.

Two sets of precursors includes:

the first agent that has polyurethane, nano-titanium metal powder, PV solvent and leveling agents which is 48:20:31.5:0.5 in weight ratio; and

the second agent consisting of curing agent and Xylene as solvent, of weight ratio 18:2.

A “nano-titanium powder incorporated polymer” slurry mixed by the first agent and the second agent with a weight ratio of 5:1 under uniformly stirring of them in the first place.

The coating process of the above-mentioned nano-titanium powder incorporated polymer coating is described in the follow procedures.

For the first layer, a PET sheet which is 250 μm in thickness and 7 cm in diameter is first cleaned by using alcohol. Then, the PET is put in a vacuum chamber followed by cleaning and activation over 15 minutes by applying a plasma of N₂/O₂ (partial pressure is 6:4). Then, put the PET on a rotating plate allowing nano-titanium powder incorporated polymer slurry admitted on it while scraping with a blade to form a uniform coating. The rotating plate is then rotated with a speed of 900 rpm for 1 minute. Remove the coated PET and put in the vacuum chamber typically at 1 torr for 5 minutes to remove the residual gas in the coating. Finally, air dried in ambient and stocked for the second layer preparation.

For the second layer, two routes are demonstrated as follows:

For the first route to form the second layer, the first layer coated PET is cleaned and activated by using the same method in the above-mentioned coating process of the first layer. Again, admit the nano-titanium powder incorporated polymer slurry on the first layer while scraping with a blade to form the uniform second layer. There is no need to rotate the PET this time. Using the same above-mentioned vacuum procedure to suck residual gas in the second layer. An ultrasonic vibratory platform to smoothlize the second layer for 10 minutes is recommended in this route. Finally, air dried in ambient.

For the second route to produce the second layer, the first layer coated PET is cleaned and activated by using the same method in the above-mentioned process of the first layer, while the rest procedures are identical to the procedures in preparing the first layer except the rotation speed is operated at 500 rpm for 30 seconds.

For further moisture permeation tests, three samples are used as follows: (1) Sample A has a total film thickness of 380±50 μm on the PET utilizing the first route to produce the second layer; (2) Sample B has a total film thickness of 250±50 μm on the PET utilizing the second route to produce the second layer; and (3) Sample C as the bare PET with a thickness of 250 μm.

Moisture permeation test is carried out according to CNS7093 moisture permeation test method of waterproof packaging material. The test sample (in sheet form) is sealed on the open end of aluminum housing, in which a dry Calcium Chloride as hygroscopic agent is stocked in it. Then, the whole assembly is placed in a cell at constant 40° C. and 90% relative humidity for 16 hours. The whole assembly is taken out of the cell and is measured in weight. Afterwards, the whole assembly is placed in the cell and taken away again for measuring the weight every 24 hours until the weight increment is 5 mg.

The test results of the three samples are given as: sample A (film thickness is 380±50, m): 0.14 μm²; sample B (film thickness is 250±50 μm): 0.99 μm²; and sample C (film thickness is 250 μm): 2.69 g/m².

As shown above, the moisture permeation of the samples A and B with the “nano-titanium polymer incorporated polymer coating” is less than that of the sample C without it.

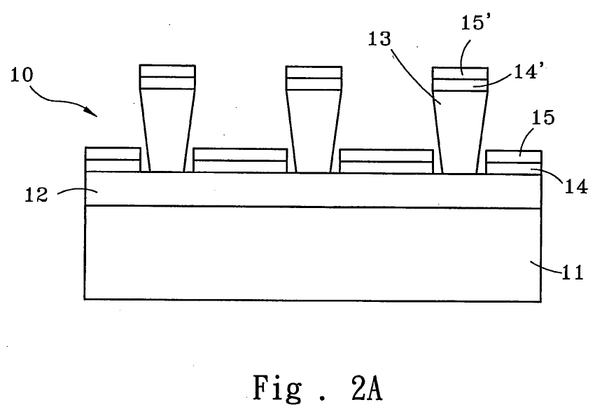

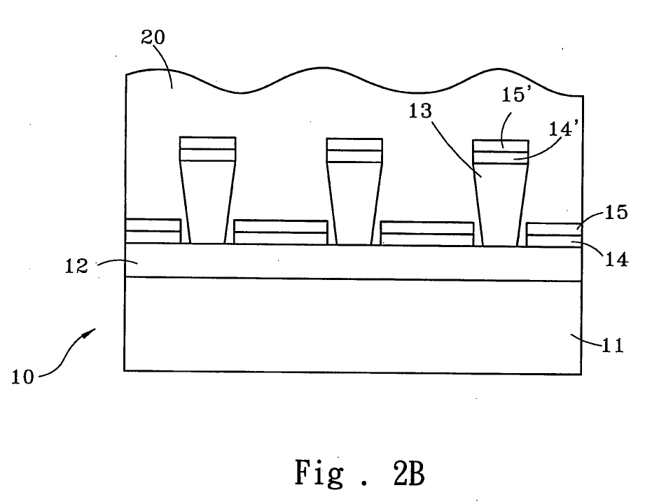

The above-mentioned performance accordingly, FIGS. 2A and 2B, an organic electroluminescence device (10) is able to adopt this invention composed of a nanometer inorganic powder and a polymer (20) to form an encapsulation material. The organic electroluminescence device (10) includes a substrate (11), an anode electric conductive layer (12) having patterned on the substrate (11), a cathode conductive layer (13) deposited on the substrate (11) and organic light emitting layers (14,14′) also deposited on the cathode conductive layer (13), wherein the organic light emitting layers (14,14′) is formed in between the cathode conductive layer (15) and the anode conductive layer (12).

The encapsulation material (20) consisting of a nanometer inorganic powder and polymer with the mixture slurry viscosity between 5,000 cps and 50,000 cps is directly coated on the organic electroluminescence device (10) to form a moisture permeation resistant layer (20) wherein the strong chemical bond is produced between surface of nanometer inorganic powder and polymer matrix. Such a moisture permeation resistant layer is flexible rather than brittle nature of the traditional package, it is therefore an objective of this invention to replace it thereby avoiding the problem of applying sealant around the package cover or fracture of the package caused by the bending of the device.

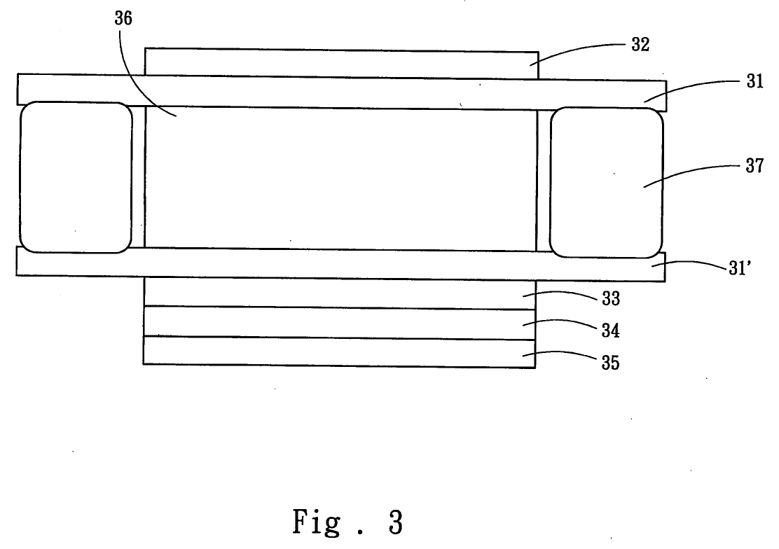

Refer to FIG. 3 for an illustration of another embodiment of this invention in use for packaging a liquid crystal display (LCD). In this case, the LCD assembly comprise of transparent substrates (31,31′), an liquid crystal dispenser component (36) comprising a liquid crystal layer between transparent substrates (31,31′) and polarizers (32,33) being sandwiched with transparent substrates (31,31′), out there a directional plate (34) and a back lighting module (35) is formed step by step on the polarizer (33), and the encapsulation material (37) could be formed on the edge of the liquid crystal orientation component (36) to seal with and fix both transparent substrates (31,31′) thus providing an alternative sealant material to the commonly used UV-curing agent and performs better water permeation resistance.

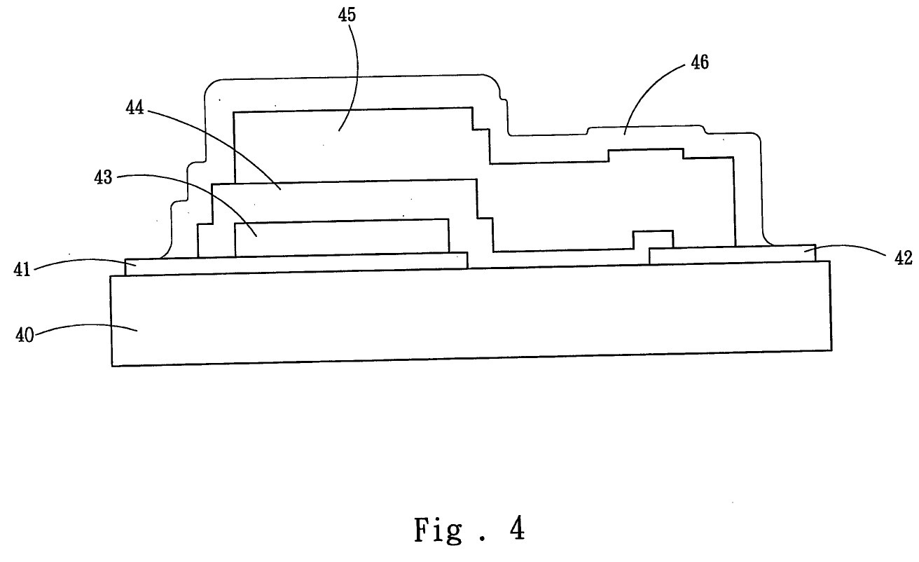

Refer to FIG. 4 for an illustration of another embodiment of this invention in use for packaging a thin film battery. As for this structure of the invention, the basic components of thin film battery comprise of a substrate (40), a cathode plate (41) located on the substrate (40) to be electrically conducted externally, an anode plate (42) corresponding to the cathode plate (41) located on the substrate (40) also to be electrically conducted externally, the cathode layer (43) located on the cathode plate (41), a solid electrolyte (44) located on the cathode layer (43) to connect with the solid electrolyte (44) and the anode plate (42), and an anode layer (45) located on the solid electrolyte (44) to be covered by the anode plate (42). The encapsulation material (46) of this invention is covered over the top most, but partial area of the cathode plate (41) and anode plate (42) should be exposed for external connection purpose.

These thin film batteries with small capacity are best applied to the low power consumption device such as memory devices, non-contact reading IC card and micro electro-mechanic devices. These products require compact design with moisture permeation resistance, which is exactly the advantage of this invention can be taken.

To summarize the practice example of the above description: The invention relates to the encapsulation material (20) by mixing the nanometer inorganic powder and the polymer. The encapsulation material (20) could be totally taking places of a traditional package using cap and absorbent material for the organic electroluminescence device (10). This invention also enables the flexible design of the organic electroluminescence device. This invention could also apply widely to the following fields:

1 The application fields of this invention:

1.1 Organic electric light emitting display (OLED), polymer light emitting display (PLED) and flexible organic light emitting display (FOLED) of general glass baseboard.

1.2 Package of integrated circuit (IC).

1.3 Package of other electronic devices.

1.4 Package of inorganic electric light emitting display (LED).

1.5 Package of thin film electroluminescence (TFEL) display.

1.6 Package of liquid crystal display (LCD).

1.7 Package of battery of solar cell, power system of solar cell, non-crystal thin film battery, single crystal and multiple crystal thin film battery, and high efficiency transparent protection layer.

2 The advantage of this invention

2.1 To increase the package effectiveness and duration of packaged devices.

2.2 To be applied widely to the packaging needs of different industries.

2.3 Both sides of devices can be insulated with moisture and air at the application of the flexible organic light emitting display (FOLED).

2.4 To reduce the effect of corrosion and oxidation since an exposed cathode or other layer are in contact with the atmosphere, and increase the packaging effect and duration of devices.

2.5 To reduce the cubic size and thickness of packaged devices.

2.6 To reduce the processing cost and time.

What is claimed is:

1. A method for packaging electronic devices comprising:
a. providing a nanometer inorganic powder and a polymer;
b. forming an encapsulation material by mixing the nanometer inorganic powder and the polymer to make a slurry with a viscosity of between 5,000 cps and 50,000 cps;
c. providing an electronic device to be packaged;
d. coating the electronic device to be packaged with the nanometer inorganic powder incorporated polymer slurry; and
e. finishing to package the electronic device after solidification of the slurry.

2. The method for packaging electronic devices according to claim 1, wherein the nanometer inorganic powder is selected from one material of group consisting of ferrum (Fe), aluminum (Al), titanium (Ti), platinum (Pt), magnesium (Mg), silver (Ag), chrome (Cr), silicon dioxde (SiO₂), titanium dioxide (TiO₂) and zinc dioxide (ZnO₂).

3. The method for packaging electronic devices according to claim 2, wherein the particle size of the nanometer inorganic powder is between 1 nm and 100 nm.

4. The method for packaging electronic devices according to claim 3, wherein the nanometer inorganic powder is manufactured by using one of a sol-gel method and a mechanical grinding method.

5. The method for packaging electronic devices according to claim 1, wherein the polymer is selected from one material of group consisting of epoxy, acrylic, urethane, polyurethane, copolymer of epoxy/acrylic, polymer mixture forming of acrylic/urethane, silicone, silioxane and organic/inorganic polymer.

6. The method for packaging electronic devices according to claim 1, wherein the encapsulation material as the step b is formed of the nanometer inorganic powder and the polymer with the best ratio of mixture.

7. The method for packaging electronic devices according to claim 1, wherein the nanometer inorganic powder and polymer therebetween is formed as chemical bonds.
